(19) United States
(12) Patent Application Publication
(10) Pub. No.: US 2009/0029336 A1
(43) Pub. Date: Jan. 29, 2009

(54) AUTOMATIC FORM CHECKING AND TRACKING

(75) Inventor: Angela Mangano, West Palm Beach, FL (US)

Correspondence Address: DARBY & DARBY P.C., P.O. BOX 770, Church Street Station, New York, NY, 10008-0770, US

(73) Assignee: MANJA, INC., West Palm Beach, FL (US)

(21) Appl. No.: 12/015,946

(22) Filed: Jan. 17, 2008

Related U.S. Application Data
(63) Continuation-in-part of application No. 11/129,973, filed on May 16, 2005.

(51) Int. Cl. G09B 7/00

(52) U.S. Cl. 434/354

(57) ABSTRACT

A method for checking forms can include retrieving user responses to entries from a hardcopy of a form, comparing at least a portion of the retrieved responses to appropriate responses for the entries specified in a stored template for the form, generating indicia responsive to the comparing step locating inappropriate responses on the hardcopy, identifying a user associated with the hardcopy; and storing the results of the comparison in a location associated with the identified user.

### CROSS REFERENCE TO RELATED APPLICATIONS

The present application is a continuation-in-part of application Ser. No. 11/129,973 entitled “AUTOMATIC PAPER GRADING AND STUDENT PROGRESS TRACKING SYSTEM” filed on May 16, 2005, which is incorporated by reference in its entirety into the present application.

### FIELD OF THE INVENTION

The present invention relates to form checking and tracking, and more particularly to systems and methods for form checking and tracking.

### BACKGROUND OF THE INVENTION

Teaching basic skills such as reading and writing in elementary school is most effectively accomplished by constant repetition, with the students completing class work and homework assignments by hand on a daily basis. This creates a tremendous workload for the teacher, who must not only grade the papers but also maintain a record of all student grades. During the course of a school year, class grades records can be maintained by a teacher in a notebook in a spreadsheet-type format. In some cases, students may receive grades using different grading criteria depending on the nature of the assignment, such as percentages (0-100%), letter grades (A-F), satisfactory/unsatisfactory indicators, rubric scores, etc. In order to compute an average grade for a given period, the teacher must typically convert all grades from dissimilar grading systems to a single numeric system.

It has been recognized that the test grading aspect of the teacher's workload can be automated. The use of automatic test scoring machines is known in the art, with the most commonly known being that which uses a test booklet with a separate tabulated scoring sheet. The scoring sheet is usually marked with special writing implements, e.g. No. 2 lead pencils, and can graded by optical or magnetic scanning. This type of scoring system necessitates rigid formats for test questions, with the most common format being multiple-choice. To provide greater flexibility for designing educational tests and the like, some devices use an optical scanner in combination with image recognition software which can read and compare handwritten indicia. However, such devices generally do not retain the score data in a memory, or otherwise track and compile score data for a student over a period of time.

Restrictions on the format and types of automated forms are typically not limited to the education environments. In many other environments, such as in government offices and businesses, much information is typically received on paper forms. However, unlike the education environment, where questions can be reformulated into a format most advantageous for an automated system to check, these other environments typically require the submission of various types of information that typically cannot be reformulated. As a result, such information typically needs to be reviewed by one or more persons not only for accuracy, but also to determine if a response is appropriate. Furthermore, after it is determined that such information is accurate, a person will still be required to enter the information manually into one or more systems.

Accordingly, there exists a need to provide systems and method for automatically evaluating submitted responses on forms and to store and track such responses for future manipulation and analysis.

### SUMMARY OF THE INVENTION

In a first embodiment of the present invention a method for checking forms is provided. The method can include the steps of retrieving user responses to entries from a hardcopy of a form, comparing at least a portion of the retrieved responses to appropriate responses for the entries specified in a stored template for the form, generating indicia responsive to the comparing step locating inappropriate responses on the hardcopy, identifying a user associated with the hardcopy; and storing the results of the comparison in a location associated with the identified user.

In a second embodiment of the present invention, a system for checking forms is provided. The system can include an optical element for acquiring images of one or more portions of a hardcopy of a form, an entry element for generating a template for the form specified appropriate responses for the form, and a storage element for storing the template. The system can further include a processing element to retrieve user responses to entries from the acquired images and the template, compare at least a portion of the retrieved responses to appropriate responses for the entries specified in the template, generate indicia responsive to locating inappropriate responses in the acquired images, identify a user associated with the hardcopy, and store the results of the comparison in a location associated with the identified user.

In a third embodiment of the present invention, a computer-readable storage medium is provided, having stored thereon, a computer program for checking forms having a plurality of code sections. The code sections can be executed by a computer and can cause the computer to perform the steps of retrieving user responses to entries from a hardcopy of a form, comparing at least a portion of the retrieved responses to appropriate responses for the entries specified in a stored template for the form, generating indicia responsive to the comparing step locating inappropriate responses on the hardcopy, identifying a user associated with the hardcopy, and storing the results of the comparison in a location associated with the identified user.

### BRIEF DESCRIPTION OF THE DRAWINGS

FIG. 1 is a schematic representation of an exemplary system for analyzing and tracking forms according to an embodiment of the present invention.

FIG. 2 is a front view of an exemplary entry unit according to an embodiment of the present invention.

FIG. 2 is a perspective view of an exemplary system having an entry unit seated in a docking station of the system according to an embodiment of the present invention.

FIG. 3 is a perspective view of an exemplary system showing a portable entry unit detached from the docking station of the system according to an embodiment of the present invention.

FIG. 5 is a view of an exemplary form for use in the various embodiments of the present invention.

FIG. 6 is an exemplary method for entering the information into the entry unit according to an embodiment of the present invention.

FIG. 7 is an exemplary method for analyzing and tracking information from forms according to an embodiment of the present invention.

FIG. 8 is a view of a form which has been analyzed by an exemplary system according to an embodiment of the present invention.

FIG. 9 is a schematic view of another exemplary system for analyzing and tracking information from forms according to another embodiment of the present invention.

FIG. 10 is a schematic view of a computer system within which a set of instructions operate according to an embodiment of the invention.

### DETAILED DESCRIPTION OF THE DRAWINGS

Although the invention will be described in terms of a few specific embodiments, it will be readily apparent to those skilled in this art that various modifications, rearrangements, and substitutions can be made without departing from the spirit of the invention. The scope of the invention is defined by the claims appended hereto.

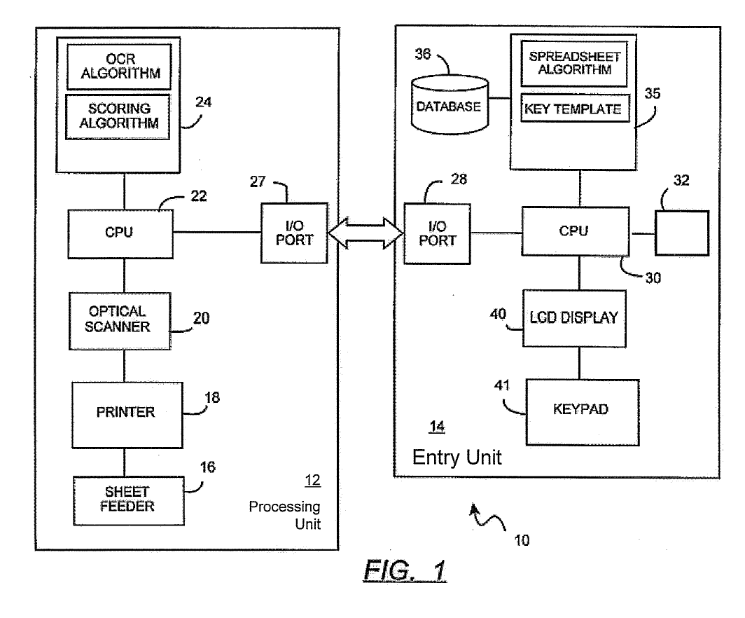

FIG. 1 schematically illustrates the components of a first embodiment of the present invention, a form checking and automated tracking system 10 configured for grading student papers and tracking of student progress. In this first embodiment, the system 10 can include a processing unit 12 and at least one entry unit 14. In use, the system 10 can include a plurality of entry units 14, each of which can be used with one or more processing units 12. In the embodiment illustrated in FIG. 1, the processing unit 12 and the entry unit 14 can each respectively include I/O data ports 27, 28, respectively, which can be coupled to one another to allow bidirectional data transmission therebetween. In the various embodiments of the present invention the processing unit 12 and the entry unit 14 can be configured to communicate using any type of wireline or wireless communication methods.

In the embodiment of FIG. 1, the processing unit 12 can include a sheet feeder 16, a printer 18 and an optical scanner 20, as well as a processor 22 which can be coupled to a memory 24. The sheet feeder 16 can also include a mechanism (not shown) for transporting hardcopies of forms through the processing unit 12. In the various embodiments, a sheet feeder 16 can be configured to receive the hardcopies and automatically guide the hardcopies through the imaging region for recognition by the optical scanner 20, and then through the printer 18. The operative mechanisms of the printer 18 can be of any type known in the art, including, without limitation, ink jet printers, laser printers, thermal printers, and/or dot matrix printers.

Resident in the memory 24 of the processing unit 12 can be optical character recognition (OCR) software which can be operable to recognize indicia on the sheets from the optically scanned image. In the various embodiments, the OCR program can be configured to recognize handwritten indicia.

In the exemplary embodiment in FIG. 1, the entry unit 14 can be any type of computing device, including, by way of example and not by way of limitation, desktop or notebook computers, personal digital assistant (PDA) device, or any other type of computing device. A front view of an exemplary design for a entry unit 14 is shown in FIG. 4. The entry unit 14 can include a display 40 and an input interface 41. In some embodiments, the input interface 41 can be configured to allow the user, to input alphanumeric data by providing a keypad. In the exemplary embodiment, entry unit 14 can also includes a CPU 30 and read-only memory 32 and/or re-writable memory 35, which can be used to store software programs 29 and/or one or more databases 26 in the entry unit 14. In some embodiments, the display 40 can also be configured to include a touch screen for data input using a stylus or fingertips. In some embodiments, the input interface 41 of the entry unit 14 can be configured accept natural human handwriting as data input, with the handwritten entries being entered on a touch screen by means of a stylus. In the various embodiments, the handwriting can either be recognized by means of an software resident in the entry unit 14, or alternatively, saved images can be recognized by the OCR program in the processing unit 12 when the entry unit 14 is coupled thereto.

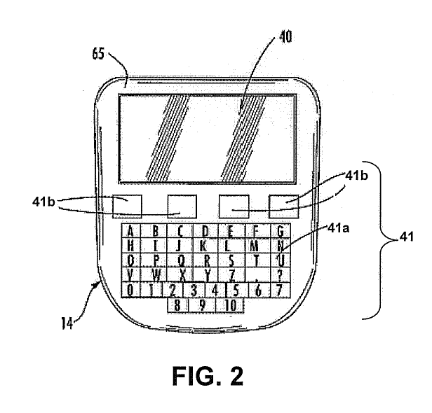

An exemplary entry unit 14 shown in FIG. 2. Along with the display 40 and an input interface 41 including a keypad 41a, the entry unit 14 can include a plurality of function keys 41b. The function keys 41b can be pre-programmed to provide short-cuts to frequently used applications. For example, in embodiments for creating templates for student document, the function keys 41b can each indicate a different type of test or assignment key to be prepared, e.g. class work, homework, quiz, test, final exam, etc. The function keys 41b can be programmed to initialize the appropriate template template for the type of test or assignment, and automatically assign the appropriate percentage weight to the test or assignment for averaging a final grade. However, the invention is not limited in this regard and the function keys can be used to provide any other function.

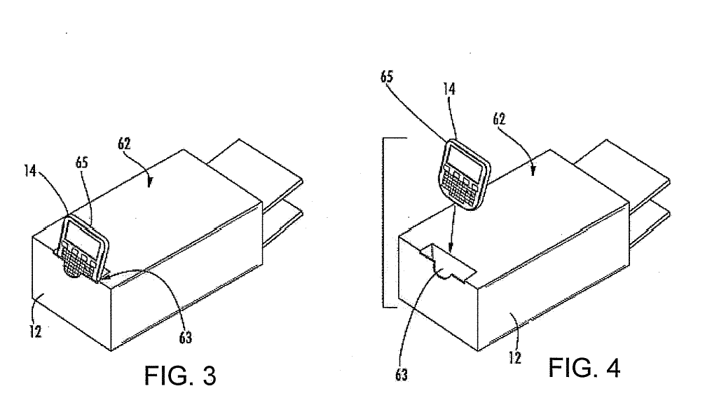

An illustration of an exemplary system having a discrete processing unit 12 and a discrete entry unit 14 is shown in FIGS. 3 and 4. For example, as shown in FIGS. 3 and 4, the processing unit 12 can have a housing 62 configured to provide a docking station 63 having the I/O data port 27 positioned therein. In such embodiments, the entry unit 14 can have a housing 65 which is configured for complimentary mated engagement with the docking station 63. Accordingly, that the I/O data ports of the processing unit 12 and the entry unit 14 can be configured so that they are aligned when the entry unit 14 is inserted therein and engaged to allow bidirectional data transmission. However, the invention is not limited in this regard and the processing unit 12 and entry unit 14 can be configured to communicate using a wireline connection or a wireless connection.

In the embodiment in FIGS. 3 and 4, the docking station 63 can also configured to accept and secure at least a portion of the entry unit 14 so that the entry unit 14 can still be operated while docked to the docking station 63. The entry unit 14 can be retained in such a manner that at least the display and input interface, such as a touch screen and/or keyboard, are readily accessible by a user.

In the various embodiments, the process of form checking and tracking can begin with the input of exemplary data for the form to be analyzed. For example, in an embodiment for grading and tracking student assignments and tests, a template can created using the entry unit by manually inputting information or by downloading information to the entry unit from an external source. The entry unit can then be coupled to the processing unit, as discussed for FIGS. 3 and 4, and subsequent data exchange between the processing unit and the entry unit then allows the processing unit to access and use the template in the entry unit.

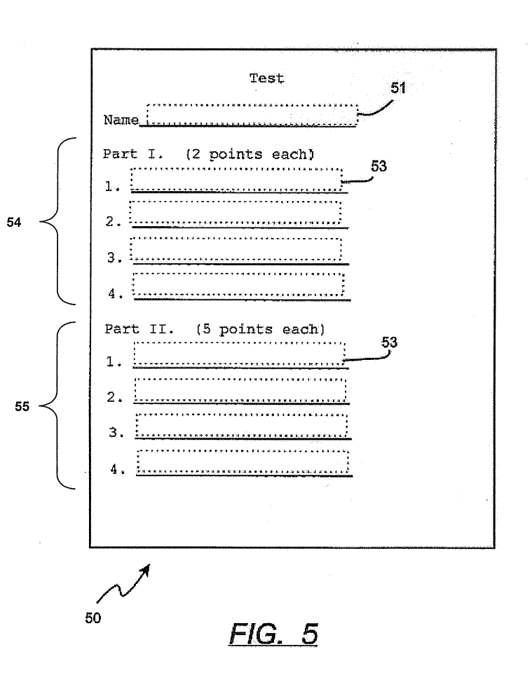

In the various embodiments, the template can entered into predefined templates for a form, which can be selected using the entry unit. For example, FIG. 5 illustrates an example of a typical template for a student assignment or test. This particular template is presented for exemplary purposes only and one or ordinary skill in art would recognize that the arrangement and content of the various forms to use with the various embodiments of the present invention can vary depending on the particular application. Although the user can completely create a template in some embodiments, in this and other embodiments the format of the template can also be selected using the entry unit by selecting predefined modes in the entry unit or by selecting a template based on information on the display of the entry unit. For example, the entry unit can be configured to allow the user to scroll through menu options on the display and select a template.

In the example shown in FIG. 5, a template 50 can include a plurality of answer fields 53. The template can also include one or more identifying fields 51. The identifying fields 51 can be used by the student to provide their name or other identifying information on the form. Although the identifying fields are not part of the assignment, they can also be optically scanned by the processing unit. Whether the user selects an existing template or creates a new template, a user can select the number of answer fields 53 to be included in the test or assignment. Each field can also be assigned a different score value at the time the template is created, and the answer fields 53 can be categorized into one or more sections 54, 55, as shown in FIG. 5.

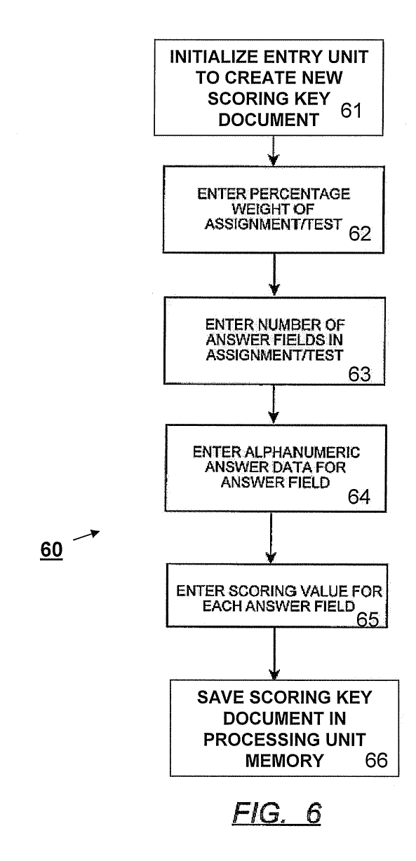

FIG. 6 illustrates an exemplary method 60 for creating a template. In Step 61 the entry unit can be initialized to create a new template document. In some embodiments, a layer of security for creating a template can be created by use of a security access code, such as a logon name and/or password for the entry unit. The user can then proceed with entering information for the template. For example, for a template for a student assignment or test, the user, in step 62, can be prompted to enter the percentage weight of the assignment or test. In step 63, the user can select the number of answer fields 53 to include in the assignment or test. The user, in step 64, can then use an alphanumeric keypad or other data entry interfaces to enter answer data for each answer field. Afterwards, the user in step 65 can enter a scoring value for each answer field in the assignment or test. In the various embodiments, the information for steps 62-65 can be entered manually into the entry unit. However, the invention is not limited in this regard and the entry unit can also be configured to retrieve the information from one or more external sources. Finally, in step 66 a template document file corresponding to the assignment or test can be saved in the memory of the processing unit. In some embodiments, an individual template file can created for each new assignment or test.

Afterwards, the test or assignment can then administered by providing each of the students with a blank test/assignment answer sheet similar to the template shown in FIG. 5. The students can hand-write their name and answer data into the appropriate fields. When the completed tests or assignments are to be graded, the assembled completed test papers can be scanned in and processed by the processing unit according to the template from the entry unit. In some embodiments, the processing unit can also require a security access code, such as logon name and password. In the various embodiments, an optical scanner can then read the indicia on each individual paper. In some embodiments, the optical scanner can be configured to detect data based on the physical locations of the designated answer fields on the template page as provided by the template. However, the invention is not limited in this regard and the processing unit can be configured to search the scanned page for indicia within the template identifying a specific question specified in the template.

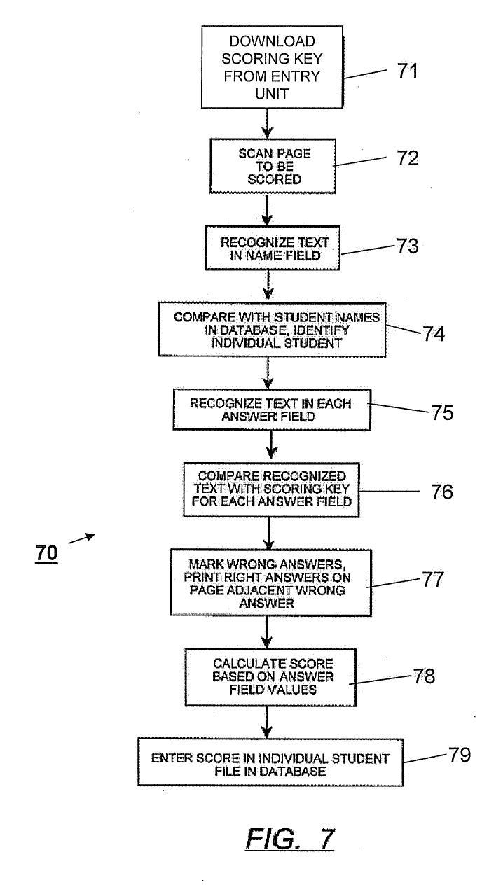

FIG. 7 illustrates an exemplary method 70 for scoring student documents. First, in step 71, the processing unit can retrieve the template from the entry unit. Afterwards, in step 72, the student documents can be scanned using the optical scanner to generate images of at least a portion of the student document. As previously discussed, the optical scanner can be configured to scan only the physical locations specified in the template or template being used. However, the invention is not limited in this regard and the entire document can be scanned into a memory of the processing unit. Once the documents have been scanned in step 72, the processing unit can retrieve the identity of the student from the document in step 73 and 74. The identity of the student can be specified in a “name” field or other identifier field. In the various embodiments, the processing unit can recognize the handwritten identity of the student using a software algorithm which includes handwriting OCR capability. The algorithm can be configured to detect and recognize indicia in any field specified by the template or anywhere else on the student document. For example, in method 70, for each paper to be graded, the OCR software can recognize the handwritten text in the name field in step 73. The recognized text from the name field in step 73 can then compared in step 74 to student names in a database resident in the memory of the entry unit 14 so that the individual student to whom the paper belongs can be identified. Afterwards, in step 75, the indicia in each field can be recognized and, in step 76, the recognized answer fields can be compared to the template for each answer field to determine correct and incorrect answers. If an incorrect answer is detected, a print command can be sent in step 77 to a printer to print indicia on the hardcopy to indicate an incorrect answer and/or to print indicia showing the correct answer. For example, the printer can mark the wrong answers with an X, and print the correct answers on the page adjacent to the wrong answer. Throughout method 70, the processing unit can keep track of correct and incorrect answers for the student document. Once all answers have been analyzed, the processing unit can calculates the total score for the student in step 78. Finally, in step 79 the score can be printed on the hardcopies and can also be entered into the individual student's files in the database in the entry unit. In some embodiments, a version of the hardcopy can be stored as well and can include the indicia associated with the incorrect answers and the student's score.

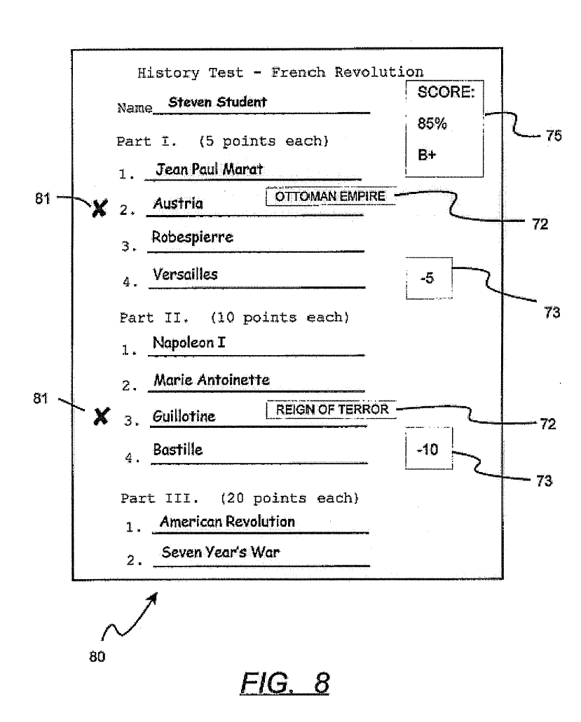

FIG. 8 illustrates an example of a test paper 80 which has been scored by the processing unit according to the various embodiments of the present invention. Incorrect answers indicated as 81 are marked with an “X.” For each incorrect answer, the correct answer 72 is printed beside the incorrect answer. The point value of each incorrect answer can also be printed, indicated as 73. The overall score 75 can also printed on the paper. In some embodiments, the printer can also be configured to print indicia on the paper in an ink color which contrasts with the ink color of the original paper. For example, if the text of the original printed template is in black ink, the scores and other indicia can be printed in red ink.

In some embodiments, the entry unit can include a computer program which provides the access to the student information database. For example, the entry unit can use a spreadsheet program or the like. In some embodiments, the computer program can be configured to operate as a teacher's grade book, and can include a listing of student names and all student grades for any number of the test and assignments which were administered in a given period. In the various embodiments, the computer program can automatically average the student grades according to the assignment and test percentage weights which have been entered by the teacher and can also allow the user to generate a hardcopy of the student records via a printer.

In other embodiments, the processing can also include spell checking or grammar checking software. This can allows users to grade or analyze allows written essay-type tests or assignments to be scored based on spelling and grammar use when the appropriate template is downloaded to the processing unit.

However, the various embodiments of the present invention are not limited to checking and tracking of only student documents. In some embodiments, the methods and systems described above can be used to check and track any types of form. In many business and government offices, many forms are received that are typically typed or handwritten. Therefore, rather than requiring manual entry of these forms into a system or manual inspection and verification of the correctness and/or appropriateness of the entry, the present invention can be used to scan, analyze, and determine if the forms have been filled out properly. Furthermore, the present invention can further provide the submitter of the form with feedback as to specific entries, indicating on the form itself any errors or issues with any of the entries. Accordingly, such forms can be received in paper form and automatically entered and processed, rather than requiring visual inspection of the form by one or more persons.

For example, the present invention can be used to analyze time entry forms. In such embodiments, the template can be configured specifying not only the layout of the time entry form, but the appropriate format and type of response required for each entry. That is, the template can be used to determine whether the entries in a time entry form have been filled out properly. Therefore, if the entries are not in the correct format or specify times or dates outside a predefined range, indicia can be printed on the time entry for to indicate the entry errors. The form can then be provided back to the employee to correct. In some cases, at least a portion of the time entry data that is correct can be stored and saved. In another example, the present invention can be used to analyze standardized forms, such as in a government office or within a business. In such embodiments, the template can be configured to analyze one or more fields in the form and determine if any fields include appropriate types of entries. If such errors are detected, the errors can be identified on the hardcopy of the form and guidance as to the proper format for the entry (or other explanation for the detected error in the form) can be provided. As in the previous example, responses in the form that are appropriate can be stored. The marked-up form can then be returned to the submitter for correction. However, the invention is not limited to these few examples and is equally applicable to any environment in which hardcopy forms are routinely received and need to be processed.

Although the various embodiments of the present invention have been described in terms of a discrete processing unit a discrete entry unit in contact with each other, the present invention is not limited in this regard. In some embodiments, the processing unit and entry unit can be combined into a general purpose computer having a computer program configured to execute all the functions of the processing unit and the entry unit, as previously described above. In such embodiments, the computer can be directly coupled to a printer and a scanner. In these embodiments, the general purpose computer can be used to generate templates, prepare the template, to operate the scanner and the printer, and to store data collected from the forms.

However, in other embodiments, the present invention can be implemented in a distributed or networked fashion. For example, system 900 depicts an exemplary arrangement of components for checking and tracking forms according to an embodiment of the present invention. System 900 can include one or more entry units 902 coupled to network 904. Entry units 902 can include any type of computing devices, including, by way of example and not by limitation, desktop computers, laptop computers, or PDAs. The system 900 can also include a processing unit 906 coupled to network 904. In the various embodiments, the processing unit 906 can be implemented as one or more centralized or distributed computing systems. Furthermore, the system 900 can include one or more remote databases 908 for storing form data, template data, or any other data for use with system 900. In the various embodiments, the entry units 902 can be configured to operate using a computer program installed in the entry units 902. However, in other embodiments, the entry units can be configured to operate using client software provided by the processing unit 906 or another server. This can allow a user to access the processing unit 906 from any device connected to the network.

In some embodiments, a printer 910 and a scanner 912 can be directly coupled to the entry unit 902, as previously discussed. However, in other embodiments, such resources can be shared and a network-based printer 914 and a network-based scanning device 916 can instead be coupled to the network 904 to provide printing and scanning functionality. Both the printer 914 and the scanner 916 can be configured to be coupled directly to the network 904 or can be coupled to the network via a server or other computing device coupled to the network 904. In some embodiments, a combination of locally and remotely coupled scanners and printers can also be used.

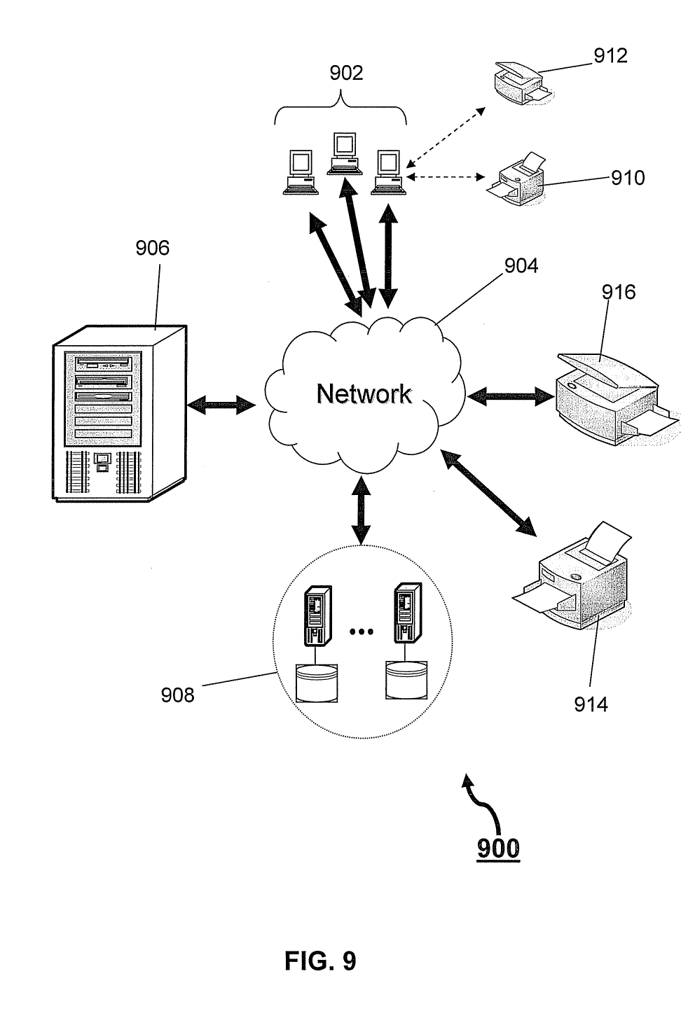

In the illustrated embodiment, FIG. 9 depicts the various components of system 900 as separate components. However, it is also within the scope of the present invention to combine the functions of one or more of these components into a single system or to provide a distributed system for performing these functions. Furthermore, although various embodiments are discussed above with reference to a check and tracking of student documents, the system and methods discussed herein are equally applicable to the checking and tracking of any type of form, as previously discussed.

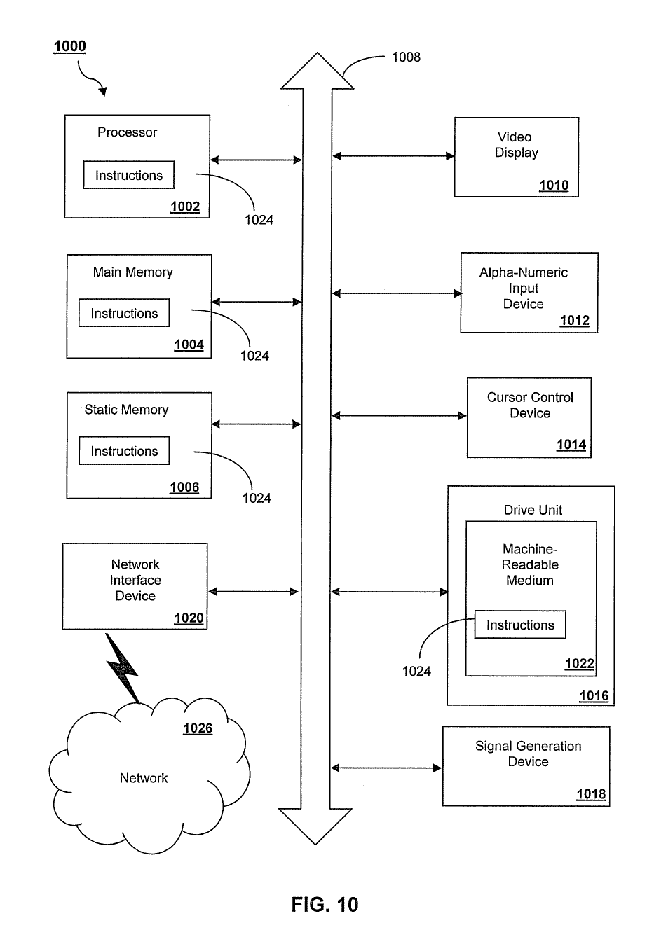

FIG. 10 is a schematic diagram of a general purpose computer system 1000 for executing a set of instructions that, when executed, can cause the computer system to perform one or more of the methodologies and procedures described above. In some embodiments, the computer system 1000 operates as a standalone device. In other embodiments, the computer system 1000 can be connected (e.g., using a network) to other computing devices. In a networked deployment, the computer system 1000 can operate in the capacity of a server or a client developer machine in server-client developer network environment, or as a peer machine in a peer-to-peer (or distributed) network environment.

The machine can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 1000 can include a processor 1002 (such as a central processing unit (CPU), a graphics processing unit (GPU, or both), a main memory 1004 and a static memory 1006, which communicate with each other via a bus 1008. The computer system 1000 can further include a display unit 1010, such as a video display (e.g., a liquid crystal display or LCD), a flat panel, a solid state display, or a cathode ray tube (CRT)). The computer system 1000 can include an input device 1012 (e.g., a keyboard), a cursor control device 1014 (e.g., a mouse), a disk drive unit 1016, a signal generation device 1018 (e.g., a speaker or remote control) and a network interface device 1020.

The disk drive unit 1016 can include a computer-readable storage medium 1022 on which is stored one or more sets of instructions 1024 (e.g., software code) configured to implement one or more of the methodologies, procedures, or functions described herein. The instructions 1024 can also reside, completely or at least partially, within the main memory 1004, the static memory 1006, and/or within the processor 1002 during execution thereof by the computer system 1000. The main memory 1004 and the processor 1002 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 1024 or that receives and executes instructions 1024 from a propagated signal so that a device connected to a network environment 1026 can send or receive voice and/or video data, and that can communicate over the network 1026 using the instructions 1024. The instructions 1024 can further be transmitted or received over a network 1026 via the network interface device 1020.

While the computer-readable storage medium 1022 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The term “wireline” shall accordingly be taken to include, but not be limited to wire-based communications using xDSL, cable, or PSTN telephony interfaces for communicating with data networks, which can include hybrid technologies that support circuit-switched packet-switched communications, as well as accessory interfaces such as USB, Firewire, and other existing and future wire-based connectivity technologies. The term “wireless” shall accordingly be taken to include, but not be limited to wireless communications using any number of wireless communication protocols or technologies. For example, wireless access technologies can include the family of 802 protocols defined by the Institute of Electrical and Electronics Engineers (IEEE) or long-range wireless access technologies such as, for example, cellular, software defined radio (SDR) and/or WiMAX. Cellular access technologies can include, for example, AMPS, CDMA-1X, UMTS/HSDPA, GSM/GPRS, TDMA/EDGE, EV/DO, and next generation technologies as they arise. Additionally, wireless communications can also include short-range wireless technologies such as optical or IR-based communications, WiFi, Bluetooth, Zigbee, cordless communications such as digital enhanced cordless telecommunications (DECT), or next generation technologies as they arise.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments can be utilized and derived therefrom, such that structural and logical substitutions and changes can be made without departing from the scope of this disclosure. Figures are also merely representational and can not be drawn to scale. Certain proportions thereof may be exaggerated, while others may be minimized. Accordingly, the specification and drawings are to be regarded in an illustrative rather than a restrictive sense.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for checking forms, the method comprising:
retrieving user responses to entries from a hardcopy of a form;
comparing at least a portion of the retrieved responses to appropriate responses for the entries specified in a stored template for the form;
generating indicia responsive to the comparing step locating inappropriate responses on the hardcopy;
identifying a user associated with the hardcopy; and
storing the results of the comparison in a location associated with the identified user.

2. The method of claim 1, wherein the generated indicia comprises at least one among the appropriate response to a user response specifying an inappropriate response, a consequence of a user response specifying an inappropriate response, and a total result of the comparing step.

3. The method of claim 1, the step of generating further comprising at least one among modifying at least one among the hardcopy or an electronic version of the hardcopy to include the generated indicia.

4. The method of claim 3, the step of modifying further comprising placing the generated indicia adjacent to the inappropriate responses in the hardcopy.

5. The method of claim 1, wherein the user responses are retrieved based on pre-defined physical locations for the entries specified in the stored template or based on a location of one or more entry identifiers specified in the stored template.

6. The method of claim 1, the step of retrieving further comprising:
optically acquiring indicia associated with the user responses on the hardcopy; and
recognizing the characters in the optically acquired indicia.

7. The method of claim 6, wherein at least a portion of the optically acquired indicia is associated with identity information of the user, the step of identifying further comprising:
comparing the acquired identity information with identity information in a database of known users; and
associating a known user in the database with the user based on the comparison.

8. A system for checking forms, the system comprising:
an optical element for acquiring images of one or more portions of a hardcopy of a form;
an interface element for generating a template for the form specified appropriate responses for the form;
a storage element for storing the template; and
a processor element to retrieve user responses to entries from the acquired images and the template, compare at least a portion of the retrieved responses to appropriate responses for the entries specified in the template, generate indicia responsive to locating inappropriate responses in the acquired images, identify a user associated with the hardcopy, and store the results of the comparison in a location associated with the identified user.

9. The system of claim 8, wherein the generated indicia comprises at least one among the appropriate response to a user response specifying an inappropriate response, a consequence of a user response specifying an inappropriate response, and a total result of the comparing step.

10. The system of claim 8, wherein the processing element is further configured to modify at least one among the hardcopy or an electronic version of the hardcopy to include the generated indicia.

11. The system of claim 10, the modifying further comprising placing the generated indicia adjacent to the inappropriate responses located in the hardcopy.

12. The system of claim 1, wherein the processing element is further configured to recognize the characters in acquired images.

13. The method of claim 12, wherein at least a portion of the acquired images are associated with identity information of the user, and where the processing element is further configured to compare the acquired identity information with identity information in a database of known users, and associate a known user in the database with the user based on the comparison.

14. A computer-readable storage medium having stored thereon, a computer program for checking forms having a plurality of code sections, the code sections executable by a computer for causing the computer to perform the steps of:
retrieving user responses to entries from a hardcopy of a form;
comparing at least a portion of the retrieved responses to appropriate responses for the entries specified in a stored template for the form;
generating indicia responsive to the comparing step locating inappropriate responses on the hardcopy;
identifying a user associated with the hardcopy; and
storing the results of the comparison in a location associated with the identified user.

15. The storage medium of claim 14, wherein the generated indicia comprises at least one among the appropriate response to a user response specifying an inappropriate response, a consequence of a user response specifying an inappropriate response, and a total result of the comparing step.

16. The storage medium of claim 14, the step of generating further comprising at least one among modifying at least one among the hardcopy or an electronic version of the hardcopy to include the generated indicia.

17. The storage medium of claim 16, the step of modifying further comprising placing the generated indicia adjacent to the inappropriate responses in the hardcopy.

18. The storage medium of claim 14, wherein the user responses are retrieved based on pre-defined physical locations for the entries specified in the stored template or based on a location of one or more entry identifiers specified in the stored template.

19. The storage medium of claim 14, the step of retrieving further comprising:
optically acquiring indicia associated with the user responses on the hardcopy; and
recognizing the characters in the optically acquired indicia.

20. The storage medium of claim 19, wherein at least a portion of the optically acquired indicia is associated with identity information of the user, the step of identifying further comprising:
comparing the acquired identity information with identity information in a database of known users; and
associating a known user in the database with the user based on the comparison.
